(19) United States
(12) Patent Application Publication
(10) Pub. No.: US 2011/0096374 A1
(43) Pub. Date: Apr. 28, 2011

(54) Image Reading Apparatus and Image Forming Apparatus

(75) Inventors: Kaoru TAKAHASHI, Kanagawa (JP); JiYoung Jeong, Incheon (KR)

(73) Assignee: FUJI XEROX CO., LTD., Tokyo (JP)

(21) Appl. No.: 12/838,005

(22) Filed: Jul. 16, 2010

(30) Foreign Application Priority Data
Oct. 22, 2009 (JP) 2009-243848

(51) Int. Cl. H04N 1/04

(52) U.S. Cl. 358/475

(57) ABSTRACT

An image reading apparatus includes light emitting elements, a circuit board, a light guide member, a support member and a heat radiation member and a reading portion. The light emitting elements emit light for illuminating an original. The light emitting elements are installed on the circuit board. The light of the light emitting elements enters into the light guide member. The support member supports the circuit board and the light guide member. The heat radiation member has a heat transmission portion to which heat generated in the light emitting elements is transmitted, and a heat radiation portion that radiates the heat conducted to the heat transmission portion. The reading portion reads an image of the original with reflection light generated in such a way that the light exiting from the light guide member is reflected from the original.

### CROSS-REFERENCE TO RELATED APPLICATIONS

This application is based on and claims priority under 35 USC 119 from Japanese Patent Application No. 2009-243848 filed on Oct. 22, 2009.

### BACKGROUND

1. Technical Field

The present invention relates to an image reading apparatus and an image forming apparatus.

2. Related Art

There is proposed an image reading apparatus in which an original is illuminated by a light source including a plurality of LED elements to read the image of the originals with light reflected from the original. The LED element changes in its light quantity and its color tone, depending upon temperatures.

### SUMMARY

According to an aspect of the invention, an image reading apparatus includes: light emitting elements that emit light for illuminating an original; a circuit board on which the light emitting elements are installed; a light guide member into which the light of the light emitting elements enters so as to be guided into a direction of the original; a support member that supports the circuit board and the light guide member; a heat radiation member that has a heat transmission portion to which heat generated in the light emitting elements is transmitted from a surface of the circuit board opposite to a surface thereof where the light emitting elements are installed, and a heat radiation portion that radiates the heat conducted to the heat transmission portion; and a reading portion that reads an image of the original with reflection light generated in such a way that the light exiting from the light guide member is reflected from the original.

### BRIEF DESCRIPTION OF THE DRAWINGS

Exemplary embodiment(s) of the present invention will be described in detail based on the following figures, wherein:

FIG. 1 is a view showing an image forming apparatus according to an exemplary embodiment of the present invention;

FIG. 2 is a schematic view showing the internal structure of an image reading apparatus according to the exemplary embodiment of the present invention;

FIG. 3A is a view showing the shape of a light guide member according to the exemplary embodiment of the present invention;

FIG. 3B is a view showing the shape of the light guide member according to the exemplary embodiment of the present invention;

FIG. 3C is a C-C sectional view of FIG. 3B, showing the shape of the light guide member according to the exemplary embodiment of the present invention;

FIG. 4A is a perspective view showing the configuration of a first carriage and its peripheral part according to the exemplary embodiment of the present invention;

FIG. 4B is an exploded perspective view of FIG. 4A, showing the configuration of the first carriage and its peripheral part according to the exemplary embodiment of the present invention;

FIG. 4C is an end face view as seen along arrows D-D in FIG. 4A, showing the configuration of the first carriage and its peripheral part according to the exemplary embodiment of the present invention;

FIGS. 5A to 5C are views showing the mounted state of a light guide member according to the exemplary embodiment of the present invention;

FIG. 6 is a view showing the mounted state of a light guide member according to the exemplary embodiment of the present invention; and

FIG. 7 is an explanatory view for explaining the operation of the exemplary embodiment of the present invention.

### DETAILED DESCRIPTION

### Configuration of Whole Image Forming Apparatus

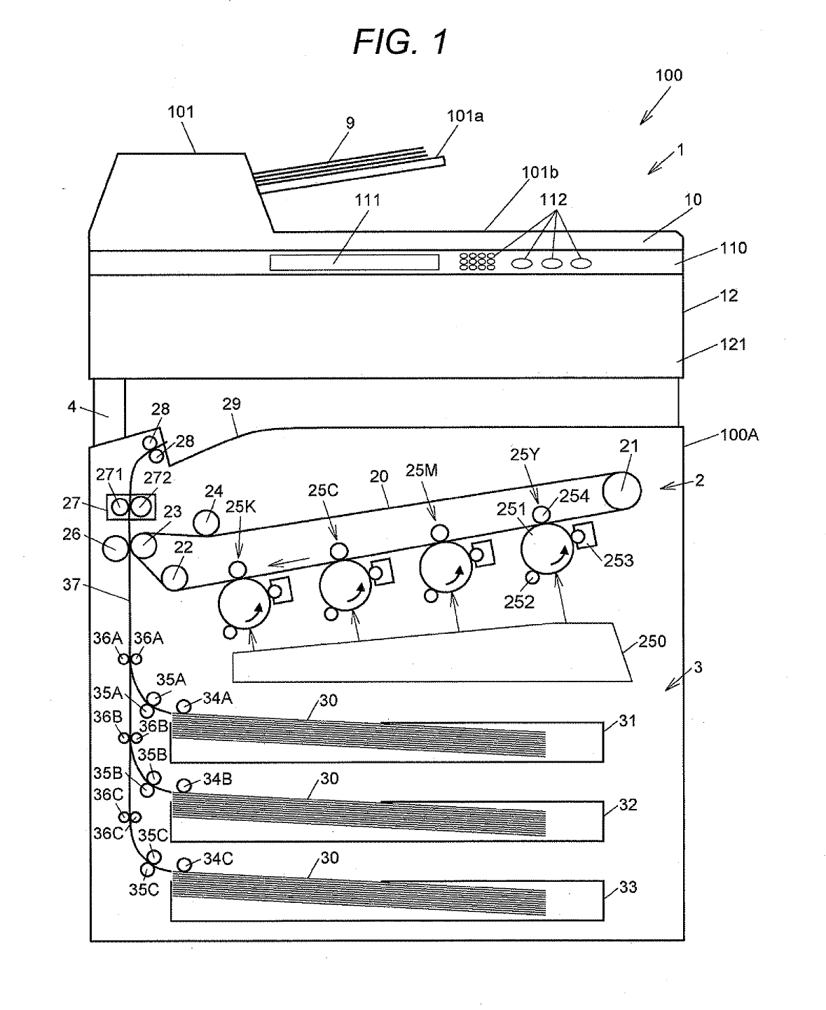

FIG. 1 shows an image forming apparatus according to an exemplary embodiment of the present invention. This figure illustrates the external appearance of an image reading apparatus 1, and the internal structure of a body portion 100A arranged on the lower side of the image reading apparatus 1.

The image forming apparatus 100 is configured including the image reading apparatus 1 which reads an image from an original 9, an image formation portion 2 which prints the image onto a sheet of paper 30 being a record medium, and a tray portion 3 which feeds the sheet of paper to the image formation portion 2. The image reading apparatus 1 is supported on the upper side of the body portion 100A by a support portion 4 so as to form a space into which the printed sheet of paper is ejected, between this apparatus 1 and the body portion 100A which accommodates the image formation portion 2 and the tray portion 3 therein.

A control panel 110 which has a touch panel 111 for presenting a manipulation menu to a user and accepting various settings, and a plurality of manipulation buttons 112, is disposed at the upper part of a front wall 121 which corresponds to the front surface of the housing 12 of the image reading apparatus 1. Besides, an original cover 10 which can be opened from or closed to the housing 12 is arranged on the upper side of the control panel 110. The original cover 10 is provided with an automatic paper feed portion 101 which conveys the original 9 put on a paper feed tray 101a, to a read position, and which ejects the original 9 after the read, onto a paper ejection bed 101b.

The image formation portion 2 includes an intermediate transfer belt 20, first through fourth image formation units 25Y, 25M, 25C and 25K which transfer toner images of the respective colors of yellow (Y), magenta (M), cyan (C) and black (K) onto the intermediate transfer belt 20, and an optical scanner 250 which projects laser beams modulated on the basis of image information, onto the first through fourth image formation units 25Y, 25M, 25C and 25K.

The first image formation unit 25Y has a photosensitive drum 251, an electric charger 252 which uniformly charges the surface of the photosensitive drum 251, a developing unit 253 which forms a toner image in such a way that an electrostatic latent image formed on the surface of the photosensitive drum 251 by the optical scanner 250 is developed with a toner, and a primary transfer roller 254 which presses the intermediate transfer belt 20 against the photosensitive drum 251. Each of the second through fourth image formation units 25M, 25C and 25K is also configured similarly to the first image formation unit 25Y.

The intermediate transfer belt 20 is driven by a driving roller 21 which is connected to a motor not shown, and it is rotated along a circulation path which is formed of a first driven roller 22, a second driven roller 23, and a tension roller 24 for imparting a tension to the intermediate transfer belt 20.

Besides, the image formation portion 2 includes a secondary transfer roller 26 which is arranged at a position that opposes to the second driven roller 23 with the intermediate transfer belt 20 interposed therebetween, a fixation unit 27 which has a fixation roller 271 with a built-in heater, and a pressing roller 272 pressed toward the fixation roller 271, and ejection rollers 28 which eject the sheet of paper having passed through the fixation unit 27, onto an ejection bed 29.

The tray portion 3 has first through third trays 31-33 in which the sheets of paper 30 that are different in a sense or size, the quality of paper, or the like, are respectively stored, and which are arranged in a vertical array.

Besides, the tray portion 3 includes pickup rollers 34A, 34B and 34C which serve to take out the stored sheets of paper 30 in correspondence with the first through third trays 31-33, respectively, separation rollers 35A, 35B and 35C which separate pluralities of sheets 30 in a case where they have been taken out, and registration rollers 36A, 36B and 36C which convey the sheets of paper 30 onto downstream sides still further. The registration rollers 36A, 36B and 36C are configured so as to operate in synchronism with the timing of image formation based on the image formation portion 2, and to guide the sheets of paper taken out of the first through third trays 31-33, between the secondary transfer roller 26 and the intermediate transfer belt 20 along a conveyance passage 37.

This image forming apparatus 100 is so configured that, in a case where the sheets of paper 30 which are different in the size or the sense are stored in the individual trays 31-33, the sheets of paper 30 fed from the respective trays 31-33 are conveyed with the center line of each of the sheets of paper 30 in substantial agreement with the center line of the conveyance passage 37 and then ejected from the ejection rollers 28 onto the ejection bed 29.

(Configuration of Image Reading Apparatus)

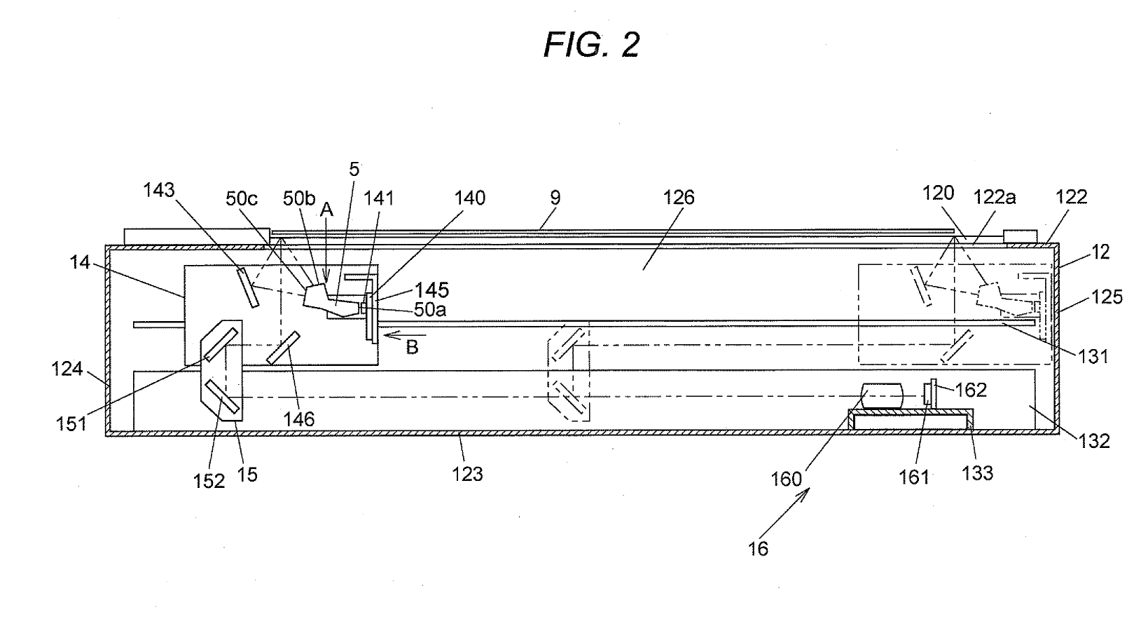

FIG. 2 is a schematic view showing the internal structure of the image reading apparatus 1. Incidentally, the illustration of the original cover 10 is omitted from this figure. The image reading apparatus 1 includes inside the housing 12, a first carriage 14 and a second carriage 15 which are arranged along a main scanning direction and which are movable in a sub scanning direction, and an image reading portion 16 which has a lens 160, a CCD (Charge Coupled Device) 161, etc. The first carriage 14 is an example of a support member.

The housing 12 is in the shape of a box in which part of an upper wall 122 facing the original cover 10 is open, and it has a bottom wall 123 which opposes to the upper wall 122, sidewalls 124 and 125 which oppose to each other in the sub scanning direction (horizontal direction in FIG. 2) while holding the bottom wall 123 therebetween, the front wall 121 stated before (refer to FIG. 1), and a rear wall 126 which opposes to the front wall 121 in the main scanning direction (direction perpendicular to the drawing sheet of FIG. 2). The upper wall 122 is formed with an opening 122a at a part corresponding to the read position of the original 9, and the opening 122a is covered with a platen glass 120 which supports the original 9.

A first rail 131 which extends in the sub scanning direction is fixed to the rear wall 126. Besides, a second rail 132 which extends in the sub scanning direction is fixed to the bottom wall 123. Such first rails 131 and such second rails 132 are arranged in the respective numbers of two so as to be arrayed in the main scanning direction, but only one first rail and one second rail are shown in FIG. 2.

Fixed to the first carriage 14 are a circuit board 140 which extends in the main scanning direction along the first carriage 14, an LED 141 being a light emitting element which is installed on the circuit board 140 and which emits light for illuminating the original 9, a heat radiation member 145 which supports the surface of the circuit board 140 opposite to the surface thereof where the LED 141 is installed, a light guide member 5 which extends in the main scanning direction along the first carriage 14 and which is arranged so as to become parallel to the circuit board 140, a reflector 143 which reflects part of emission light from the light guide member 5, to the direction of the original 9, and a first mirror 146 which receives reflection light from the original 9. A plurality of such LEDs 141 are installed on the circuit board 140, and the plurality of LEDs 141 constitute a light source as a whole.

The first carriage 14 illuminates the image read position of the original 9 while moving in the sub scanning direction together with the individual members such as the light guide member 5, under the guide of the first rails 131, and the reflection light of the original 9 is reflected toward the second mirror 151 of the second carriage 15 to be stated later, by the first mirror 146.

The light guide member 5 is a bar-shaped polyhedron which is formed of a polymethyl methacrylate resin or the like material having a light transmissivity, and it has an entrance face 50a into which the light of the LED 141 enters, a first exit face 50b from which part of light having entered from the entrance face 50a exits toward the original 9, and a second exit face 50c from which the other part of the light having entered from the entrance face 50a exits to the direction of the reflector 143.

The circuit board 140 contains an epoxy resin, a glass fiber or the like as a main content, and the front surface thereof is formed with a wiring pattern for feeding a current to the LED 141.

Fixed to the second carriage 15 are the second mirror 151 which receives the reflection light from the first mirror 146 stated before, and a third mirror 152 which receives reflection light from the second mirror 151.

The second carriage 15 reflects the reflection light of the original 9 toward the lens 160 of the image reading portion 16 while moving in the sub scanning direction under the guide of the second rails 132.

The first carriage 14 and the second carriage 15 are driven by a drive mechanism not shown, and they are so configured that the movement magnitude of the second carriage 15 becomes half of the movement magnitude of the first carriage 14 lest an optical path length from the image read position of the original 9 to the CCD 161 to be stated later should fluctuate during the movement of the first carriage 14 in the sub scanning direction. The first carriage 14 and the second carriage 15 at the time when the first carriage 14 has moved to the vicinity of the end part of the original 9 in the sub scanning direction, are shown by two-dot chain lines in FIG. 2.

The image reading portion 16 has a lens 160 which is fixed to a base plate 133 supported on the second rails 132, and a circuit board 162 on which the CCD (Charge Coupled Device) 161 is mounted.

The image reading portion 16 is so configured that reflection light from the third mirror 152 passes through the lens 160 to be focused on the CCD 161, and that the image of the original 9 is read by the CCD 161 so as to output image data.

(Shape of Light Guide Member)

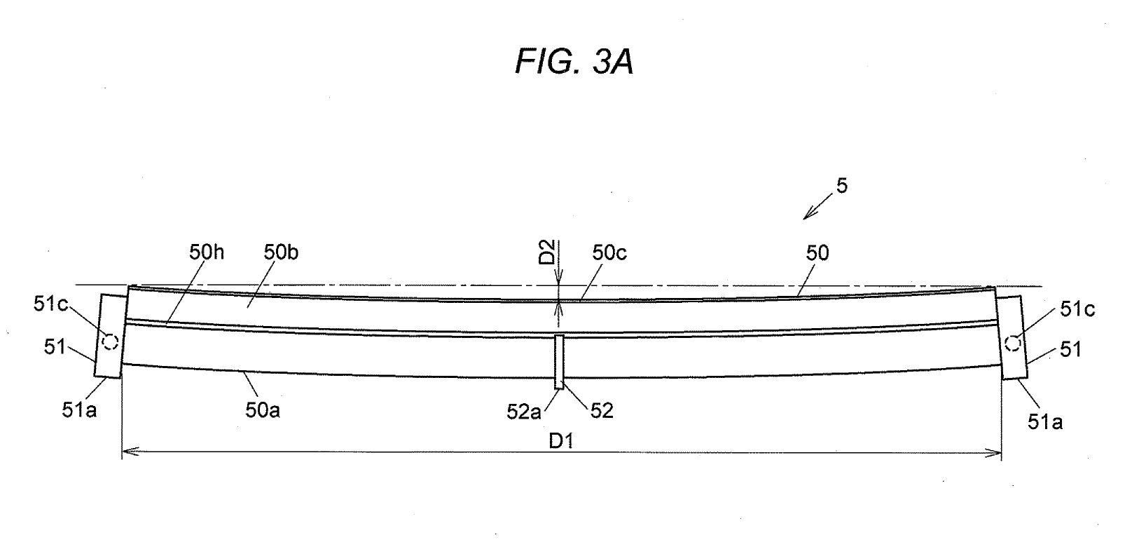

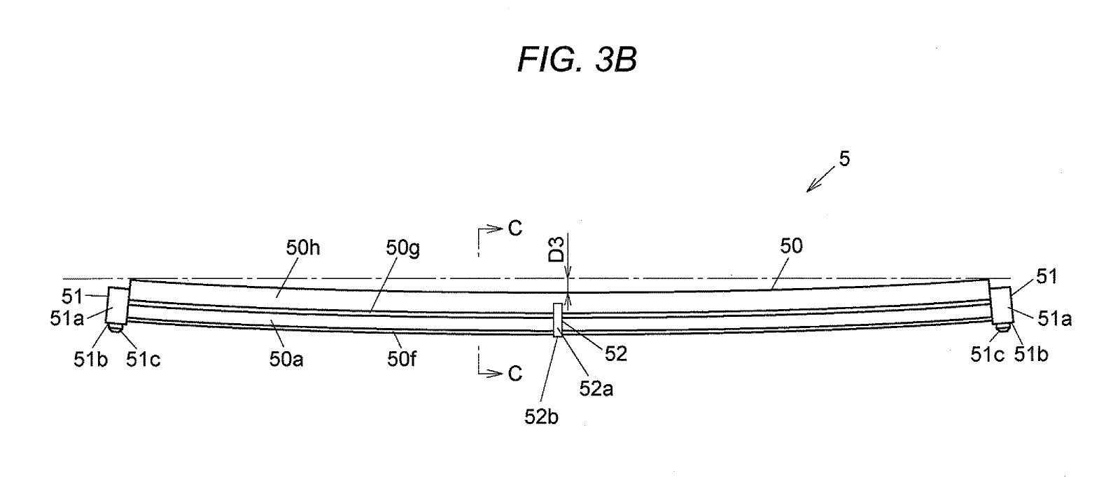

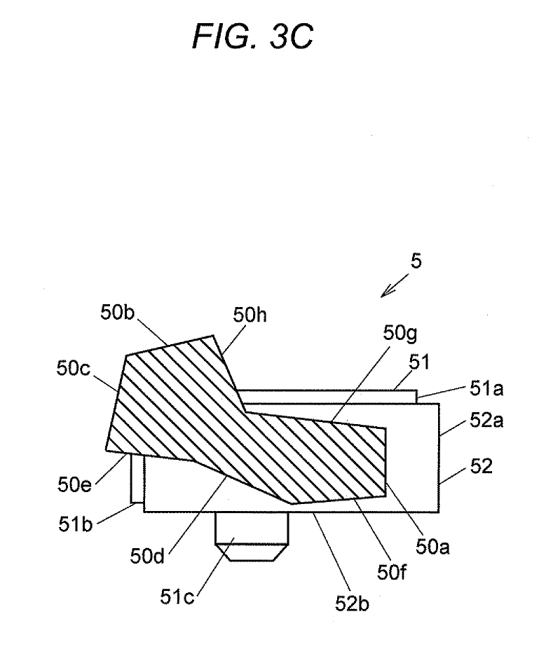

FIGS. 3A through 3C are views each showing the shape of the light guide member 5 as a simple component, in which FIG. 3A shows the shape as seen in the direction of an arrow A in FIG. 2, parallel to the circuit board 140, FIG. 3B shows the shape as seen in the direction of an arrow B in FIG. 2, orthogonal to the circuit board 140, and FIG. 3C shows the shape of a section C-C in FIG. 3B. By the way, in each of these figures, the bending of the light guide member 5 is exaggeratedly represented for the sake of elucidation.

As shown in FIG. 3A, the light guide member 5 unitarily includes a body portion 50, a pair of first protuberances 51 which are formed at both the end parts of the body portion 50 in the lengthwise direction thereof, and a second protuberance 52 which is formed at the middle part of the body portion 50 in the lengthwise direction thereof.

The body portion 50 has the entrance face 50a, and first and second exit faces 50b and 50c, and it bends in a first direction in which the middle part protrudes onto the side of the entrance face 50a in the lengthwise direction (right and left direction in FIG. 3A). Letting D1 denote the length of the body portion 50 in the lengthwise direction thereof, and D2 denote the displacement magnitude of the middle part relative to a straight line which couples both the end parts 50 in the lengthwise direction thereof, the rate (bending factor) of the displacement magnitude D2 to the length D1 should desirably be 0.1-0.5% and more desirably be 0.2-0.4%. In this exemplary embodiment, the rate is set at 0.3%.

Besides, the dimension of the displacement magnitude D2 should desirably be made 0.3-1.5 mm and more desirably be made 0.6-1.2 mm. In this exemplary embodiment, the dimension of the displacement magnitude D2 is set at 1.0 mm.

Each of the first protuberances 51 protrudes in a direction perpendicular to the entrance face 50a, beyond this entrance face 50a, and a distal end face 51a is formed at the distal end of the protrusive part.

The second protuberance 52 protrudes the same distance as the protrusive distance of each first protuberance 51 from the entrance face 50a, toward the direction perpendicular to the entrance face 50a beyond this entrance face 50a, and a distal end face 52a is formed at the distal end of the protrusive part.

As shown in FIG. 3B, the light guide member 5 bends so that the middle part thereof may protrude in the lengthwise direction (right and left direction in FIG. 3B), also in a second direction which intersects orthogonally to the first direction stated before.

The first and second protuberances 51 and 52 are formed so as to protrude beyond the body portion 50 in the thickness direction of the light guide member 5 (up and down direction in FIG. 3B), and a distal end face 51b is formed at the distal end of each of the protrusive parts of the first protuberances 51. The distal end face 51b is formed with a boss portion 51c whose base end part on the side of the distal end face 51b is in a circular pillar shape and whose distal end part gradually decreases in diameter. Besides, a flat distal end face 52b is formed at the distal end of the protrusive part of the second protuberance 52. When seen in the direction shown in FIG. 35, the protrusion magnitude of the distal end face 51b of each first protuberance 51 relative to the body portion 50 is the same as that of the distal end face 52b of the second protuberance 52.

As shown in FIG. 3C, the body portion 50 of the light guide member 5 is formed with a first reflection face 50d which reflects part of the light having entered from the entrance face 50a, toward the first exit face 50b, a first side face 50e which is formed between the first reflection face 50d and the second exit face 50c, a second side face 50f which is formed between the first reflection face 50d and the entrance face 50a, a second reflection face 50g which reflects part of the light having entered from the entrance face 50a, toward the second exit face 50c, and a third side face 50h which is formed between the second reflection face 50g and the first exit face 50b.

The entrance face 50a and the distal end face 52a of the second protuberance 52 are formed so as to become parallel to each other, and the distal end face 52b of the second protuberance 52 is formed so as to become right-angled to the distal end face 52a.

Each of the first protuberances 51 is formed having the same shape and the same dimensions as those of the second protuberance 52 in a section orthogonal to the center axis of the light guide member 5, but only the part thereof as seems to shift from the second protuberance 52 on account of the bending of the light guide member 5 is illustrated in FIG. 3B.

In a state where any external force does not act on the light guide member 5, the respective faces 50a-50h of the body portion 50 bend relative to the lengthwise direction thereof, but the light guide member 5 has a flexibility enough to flex until it becomes, at least, parallel to the lengthwise direction by an external force, and it has an elasticity with which it returns into the original bending shape, when the external force has been removed.

Incidentally, the bending shape of such a light guide member 5 can be formed by, for example, changing the temperatures of a metal mold in injection molding, in dependency upon parts.

(Configurations of First carriage, and Members fixed to First carriage)

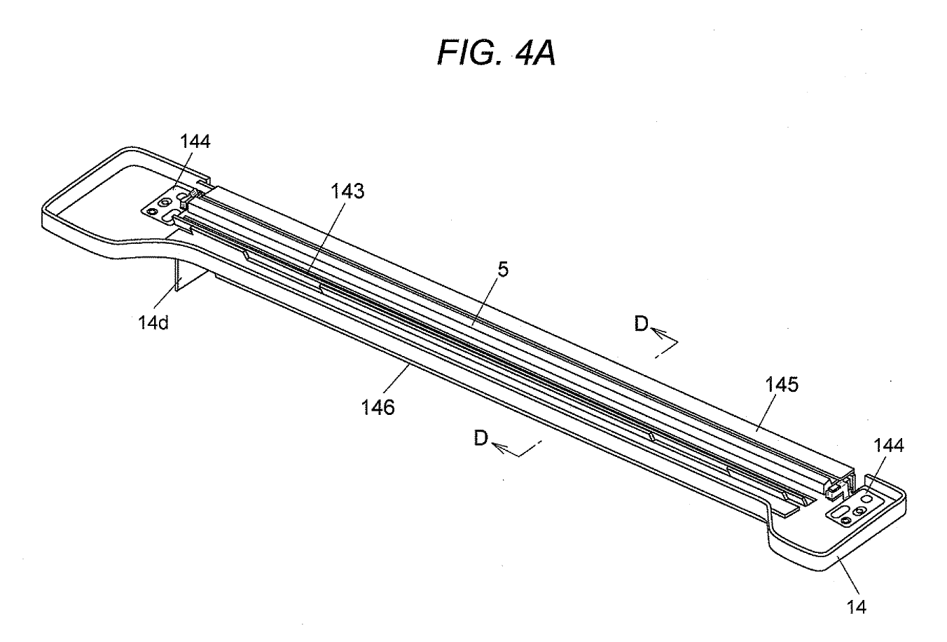

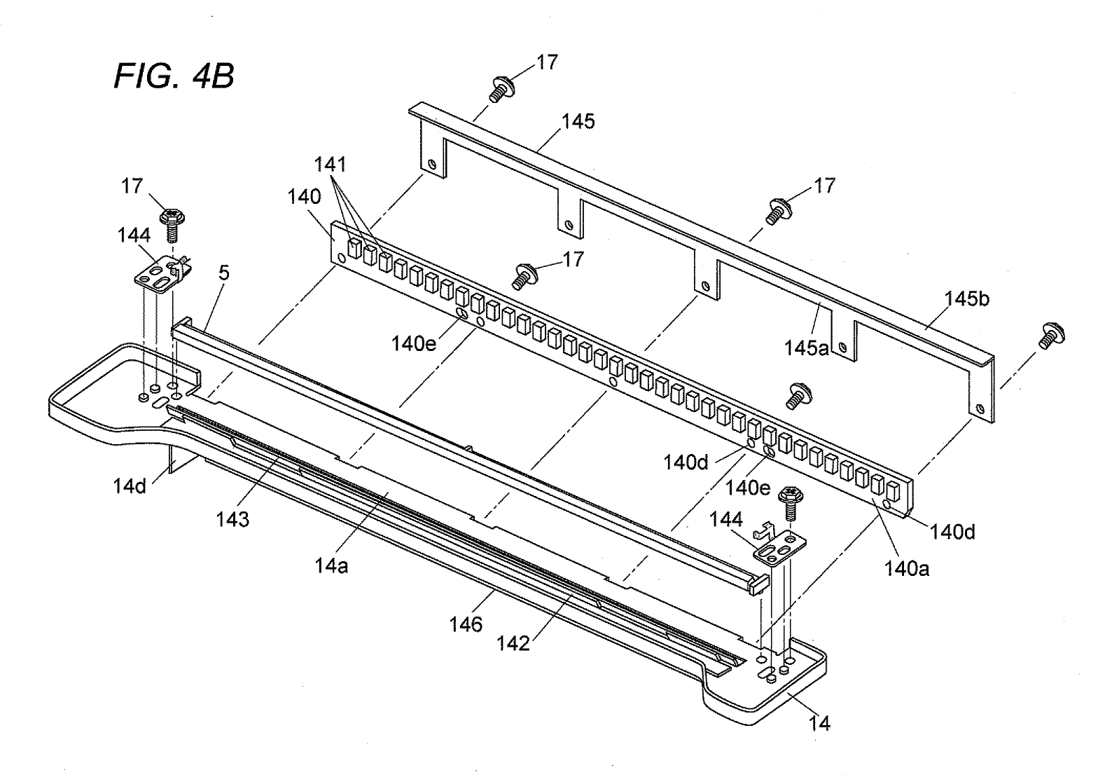

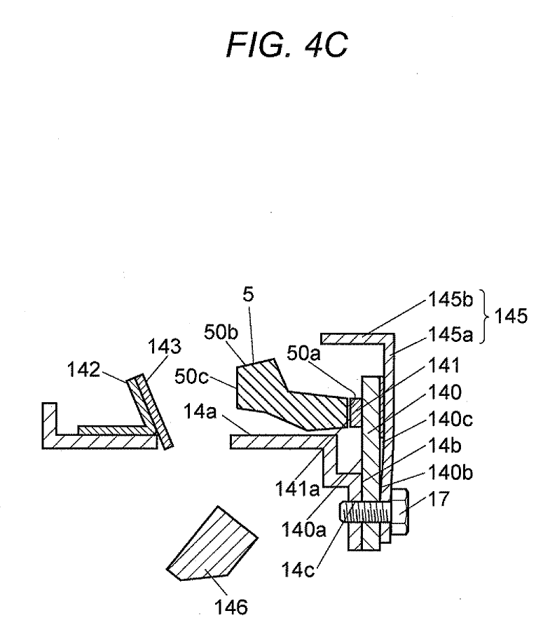

FIGS. 4A through 4C are views showing the first carriage 14, and the light guide member 5, the circuit board 140, the reflector 143, the first mirror 146, etc. fixed to the first carriage 14, in which FIG. 4A is a perspective view showing a state where these members are fixed to the first carriage 14, FIG. 4B is an exploded perspective view, and FIG. 4C is an end face view as seen along arrows D-D in FIG. 4A.

The first carriage 14 is molded from a metal plate such as a zinc-plated steel plate, and it is formed so as to extend in the main scanning direction. Both the end parts of the first carriage 14 are supported so as to be slidable on the first rails 131.

As shown in FIG. 4B, a support face 14a for supporting the light guide member 5 is formed along the lengthwise direction, in the first carriage 14. The first support face is a flat surface which is formed so as to become parallel to the main scanning direction and to the sub scanning direction orthogonal to the main scanning direction.

The first carriage 14 is provided with a reflector mounting base 142 in parallel with the support face 14a, and the reflector 143 is mounted on the reflector mounting base 142. Besides, a mirror mounting plate 14d is provided under the reflector mounting base 142, and the first mirror 146 is mounted on the mirror mounting plate 14d.

Besides, the first carriage 14 is formed with a circuit-board mounting face 14b which is continuous to the support face 14a, and which is crooked at right angles to the sub scanning direction with respect to the support face 14a (refer to FIG. 4C). In the circuit-board mounting face 14b, screw holes 14c for screwing the circuit board 140 are provided in a plurality of places (five places in this exemplary embodiment).

As shown in FIG. 4B, the plurality of LEDs 141 (46 LEDs in this exemplary embodiment) are installed in one row along the main scanning direction, on the front surface 140a of the circuit board 140. The circuit board 140 is formed with five through holes 140d in correspondence with the screw holes 14c in the five places of the first carriage 14, respectively. Besides, the circuit board 140 is formed with slots 140e for tentatively fitting the circuit board 140 when this circuit board is to be assembled to the first carriage 14.

As shown in FIG. 4C, a sheet-like heat transmission member 140c which has an electric insulability and a thermal conductivity is stuck on that rear surface 140b of the circuit board 140 which corresponds to a region where the LED 141 is fixed. The circuit board 140 is screwed to the screw holes 14c in the five places of the circuit-board mounting face 14b, by bolts 17, and it is fixed to the first carriage 14. The heat transmission member 140c is made from, for example, silicone.

As shown in FIGS. 4B and 4C, a heat radiation member 145 is arranged in opposition to the rear surface 140b of the circuit board 140. The heat radiation member 145 has a flat heat transmission portion 145a which touches the rear surface 140b of the circuit board 140, and a heat radiation portion 145b which is formed in a manner to be crooked at right angles toward the circuit board 140 relative to the heat transmission portion 145a. The heat radiation member 145 is made from a metal plate such as a zinc-plated steel plate, and the thickness thereof is, for example, 0.5 mm.

The heat transmission portion 145a of the heat radiation member 145 is screwed to the screw holes 14c in the three places of the circuit-board mounting face 14b, by the bolts 17 together with the circuit board 140, in touch with the rear surface 140b of the circuit board 140 and the heat transmission member 140c, and it is fixed to the first carriage 14.

As shown in FIG. 4C, the heat transmission ember 140c is not stuck to the parts at which the circuit board 140 is screwed. Therefore, the circuit board 140 and the heat radiation member 145 are elastically deformed in correspondence with the thickness of the heat transmission member 140c, and that heat transmission portion 145a of the heat radiation member 145 which faces the heat transmission member 140c is pressed against the heat transmission member 140c.

The heat radiation portion 145b of the heat radiation member 145 lies above the light guide member 5 in a vertical direction, and it covers the upper part of the light emission face 141a of the LED 141 to prevent the light emitted from the LED 141 directly entering into the eyes of the user.

(Holding of Light Guide Member)

As shown in FIGS. 4A and 4B, the light guide member 5 has the first protuberances 51 supported by holding members 144 which are fixed to the first carriage 14, and it has the second protuberance 52 supported by the support face 14a of the first carriage 14 and the front surface 140a of the circuit board 140.

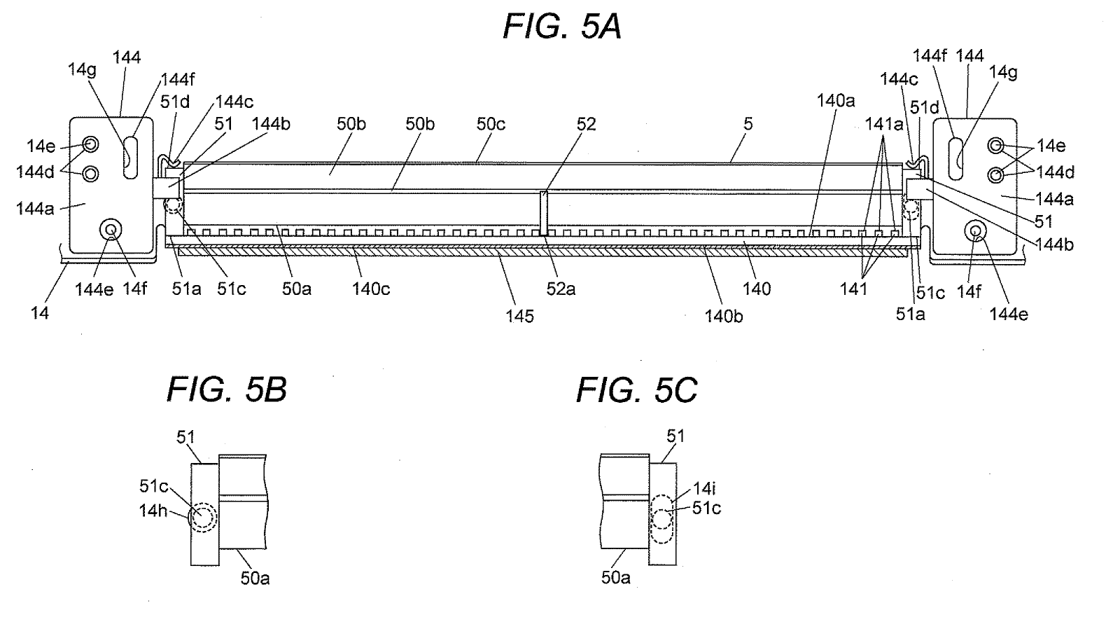

FIGS. 5A to 5C are views in which the light guide member 5 attached to the first carriage 14 is seen from an upper side in a direction perpendicular to the support face 14a, and in which FIG. 5A is a view showing the light guide member 5 and the peripheral parts thereof, and FIG. 5B and FIG. 5C are partial enlarged views. Incidentally, FIG. 5A shows a state where the heat radiation portion 145b of the heat radiation member 145 has been removed.

As shown in FIG. 5A, the 46 LEDs 141 are installed at equal intervals on the circuit board 140, and the distal end face 52a of the second protuberance 52 of the light guide member 5 touches the front surface 140a of the circuit board 140 at the position between the two LEDs 141 lying at a central part (between the 23rd and 24th LEDs 141 as reckoned from one end part side of the circuit board 140).

Each of the first protuberances 51 of the light guide member 5 is supported by the holding member 144 so that the first touch face 51a thereof may be urged toward the front surface 140a of the circuit board 140.

The holding member 144 unitarily includes a flat face portion 144a which touches the first carriage 14, a first arm 144b which urges the first protuberance 51 of the light guide member 5 against the support face 14a of the first carriage 14, and a second arm 144c which urges the first protuberance 51 of the light guide member 5 against the front surface 140a of the circuit board 140.

The second arm 144c has the distal end part thereof held in touch with the rear face 51d of the first protuberance 51 as corresponds to the opposite side of the distal end face 51a of this first protuberance. The first and second arms 144b and 144c have elasticities, and they urge the first protuberance 51 in states where they are elastically deformed.

Besides, the flat face portion 144a of the holding member 144 is formed with two locating holes 144d into which two protrusions 14e formed on the first carriage 14 are snugly fitted and which serve to position the holding member 144, a penetrating hole 144e which is provided at a position corresponding to a screw hole 14f formed in the first carriage 14 and through which the bolt 17 for fixing the holding member 144 to the first carriage 14 is penetrated, and a slot 144f which is provided in correspondence with the opening 14g of the first carriage 14.

Since the second protuberance 52 of the light guide member 5 touches the front surface 140a of the circuit board 140, and the first protuberances 51 thereof at both the end parts in the lengthwise direction are urged toward the front surface 140a of the circuit board 140 by the holding members 144, this light guide member 5 is supported in a state where it is elastically deformed from a bent shape into a rectilinear shape so that the entrance face 50a may become parallel to the front surface 140a of the circuit board 140. The distal end face 52a of the second protuberance 52 is urged against the front surface 140a of the circuit board 140 by the elasticity of the light guide member 5 itself.

The protrusive magnitude of each of the first and second protuberances 51 and 52 from the body portion 50 is larger than the distance of the light emission face 141a of each LED 141 from the circuit board 140, and the body portion 50 of the light guide member 5 is located at a position at which a gap is formed between the entrance face 50a and the light emission face 141a of each LED 141.

FIG. 5B shows on enlarged scale the peripheral parts of the first protuberance 51 on a left side in FIG. 5A. The boss portion 51c formed on the first protuberance 51 is snugly fitted into a penetrating hole 14h formed in the first carriage 14. The diameter of the penetrating hole 14h is made larger than that of the cylindrical part of the boss portion 51c so as to absorb expansion and shrinkage in the lengthwise direction of the light guide member 5 as are ascribable to the temperature changes of this light guide member.

FIG. 50 shows on enlarged scale the peripheral parts of the first protuberance 51 on a right side in FIG. 5A. The boss portion 51c formed on the first protuberance 51 is snugly fitted into a slot 14i formed in the first carriage 14. The slot 14i is formed so as to extend in a direction orthogonal to the lengthwise direction of the light guide member 5, and the length of the slot 14i in the widthwise direction thereof, along the lengthwise direction of the light guide member 5, is a dimension which is smaller than the diameter of the penetrating hole 14h stated before and which is slightly larger than the diameter of the cylindrical part of the boss portion 51c. Besides, the length of the slot 14i in the lengthwise direction thereof is set at a dimension which allows the deformation of the light guide member 5 from the bent shape into the rectilinear shape.

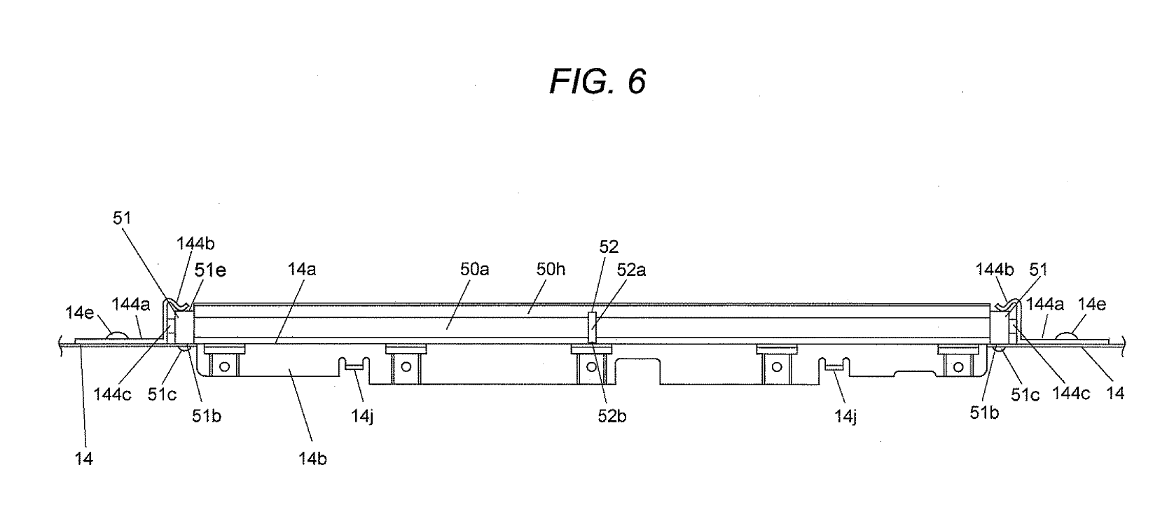

FIG. 6 is a view in which the light guide member 5 mounted on the first carriage 14, and the peripheral parts thereof are seen from a direction perpendicular to the circuit-board mounting face 14b.

The first arm 144b of the holding member 144 touches a rear surface 51e which corresponds to a side opposite to the distal end face 51b of the first protuberance 51 of the light guide member 5, whereby the first protuberance 51 is urged toward the support face 14a of the first carriage 14. Besides, the distal end face 52b of the second protuberance 52 is urged against the support face 14a by the elasticity of the light guide member 5 itself.

In this manner, the light guide member 5 is supported by the holding members 144 and the support face 14a so that the gap may be formed between the body portion 50 and the support face 14a of the first carriage 14 in the state where this light guide member is elastically deformed from the bent shape before assemblage, into the rectilinear shape.

(Assembling Procedure)

Next, there will be described a procedure in which the first carriage 14, the light guide member 5, the circuit board 140 and the heat radiation member 145 are assembled.

An operator who performs an assembling operation arranges the light guide member 5 on the support face 14a in such a manner that the boss portion 51c formed on one first protuberance 51 of the light guide member 5 is snugly fitted into the slot 141 of the first carriage 14, while the boss portion 51c formed on the other first protuberance 51 of the light guide member 5 is snugly fitted into the penetrating hole 14h of the first carriage 14.

Subsequently, the operator fixes the two holding members 144 to the first carriage 14 so as to support the pair of first protuberances 51. In the process in which the holding members 144 are fixed, the bent shape of the light guide member 5 as shown in FIG. 3B is deformed into the rectilinear shape. Besides, at this stage, parts of the first protuberances 51 and the second protuberance 52 protrude from the support face 14a of the first carriage 14 toward a side on which the circuit board 140 is mounted.

Subsequently, the operator snugly fits protrusions 14j in two places as are formed on the circuit-board mounting face 14b, into the slots 140e of the circuit board 140, thereby to support the circuit board 140. In this state, he/she screws the circuit board 140 in two of the screw holes in the five places as are formed in the circuit-board mounting face 14b, thereby to fix the circuit board 140. In the process in which the circuit board 140 is fixed, the light guide member 5 is pressed by the circuit board 140 and has its bending rate lessened, thereby to be deformed into the rectilinear shape.

Subsequently, the operator co-clamps the circuit board 140 and the heat radiation member 145 by the bolts 17 in the remaining three of the screw holes in the five places as are formed in the circuit-board mounting face 14b, thereby to fix the heat radiation member 145 to the first carriage 14. The first carriage 14, light guide member 5, circuit board 140 and heat radiation member 145 are assembled as stated above.

### Operation of this Exemplary Embodiment

Next, the operation of this exemplary embodiment will be described separately for (1) the operation of the image forming apparatus and (2) the suppression of the deformation of the light guide member.

(1) Operation of Image forming apparatus 100

When the user puts the original 9 on the paper feed tray 101a or on the platen glass 120 and then gives the instruction of the duplication of the original by manipulating the touch panel 111 and the manipulation buttons 112 of the control panel 110, the image reading apparatus 1 starts reading an image. In the case where the original 9 has been put on the paper feed tray 101a, the control portion (not shown) of the image reading apparatus 1 controls the automatic paper feed portion 101 so as to convey the original 9 to the read position on the platen glass 120.

The control portion of the image reading apparatus 1 causes the plurality of LEDs 141 to emit light by feeding currents thereto, and it drives the first and second carriages 14 and 15 in the sub scanning direction by controlling the drive mechanism. Light having entered into the entrance face 50a of the light guide member 5 exits from the first exit face 50b of the light guide member 5 or from the second exit face 50c, the exiting light is reflected by the reflector 143, and the reflected light illuminates the original 9. Reflection light reflected from the front surface of the original 9 is reflected by the first mirror 146, the second mirror 151 and the third mirror 152, and the resulting light enters into the lens 160 of the image reading portion 16.

Light transmitted through the lens 160 is focused on the CCD 161, thereby to read the image of the original 9 by the CCD 161. The control portion of the image reading apparatus 1 sends image data being the read result of the image, to the optical scanner 250 of the image formation portion 2. Thereafter, in the case where the control portion has read the original 9 put on the paper feed tray 101a, it controls the automatic paper feed portion 101 so as to eject the original 9 onto the ejection bed 101b.

The optical scanner 250 projects light beams modulated on the basis of the image data of the respective colors Y, M, C and K, onto the photosensitive drums 251 charged by the electric chargers 252, thereby to form electrostatic latent images on the surfaces of the photosensitive drums 251. The electrostatic latent images are developed with toners by the developing units 253, whereby toner images are formed. The toner images on the photosensitive drums 251 are transferred onto the intermediate transfer belt 20 by the primary transfer rollers 254.

On the other hand, the sheet of paper 30 is taken onto the sheet conveyance passage 37 by the pickup roller 34A from any of the first through third trays 31-33, for example, the first tray 31, it is separated by the separation rollers 35A, and it is thereafter conveyed between the secondary transfer roller 26 and the intermediate transfer belt 20 by the registration rollers 36A, whereby the toner images on the intermediate transfer belt 20 are transferred onto the sheet of paper 30.

Thereafter, the toner images on the sheet of paper 30 are fixed by the fixation unit 27, whereupon the resulting sheet of paper 30 is ejected onto the ejection bed 29 by the ejection rollers 28.

(2) Suppression of Deformation of Light Guide Member

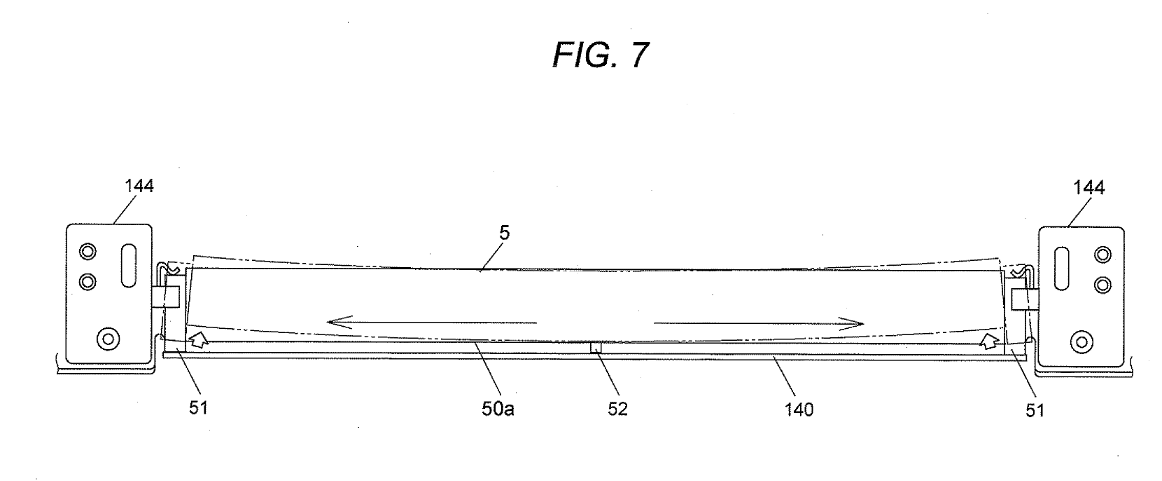

As shown in FIG. 7, when the entrance face 50a of the light guide member 5 is heated by heat which is generated from the LEDs 141 during the use of the image forming apparatus 1, the heated part inflates to generate a force which warps the light guide member 5 so that both the end parts of the light guide member 5 may come away from the front surface 140a of the circuit board 140 and that the middle part thereof may protrude toward the circuit board 140. However, the rear surface 140b of the circuit board 140 is supported by the heat radiation member 145, and the deformation of the circuit board 140 simultaneous with the light guide member 5 is suppressed.

### Other Exemplary Embodiments

By the way, the present invention is not restricted to the individual exemplary embodiments, but it is capable of various modifications within a scope not altering the purport thereof.

The shape of the light guide member 5 is not restricted to the one shown in the foregoing exemplary embodiments, but it may well be the shape of, for example, a rectangular parallelepiped. Besides, the second protuberance 52 has been disposed in one place of the middle part in the lengthwise direction of the light guide member 5, in the foregoing exemplary embodiments. However, this is not restrictive, but a plurality of second protuberances 52 may well be disposed between the first protuberances 51 formed at both the end parts. Besides, the material of the light guide member 5 is not especially limited.

The places where the light guide member 5 is held by the holding members 144 are not restricted to the vicinities of the end faces of the light guide member 5 in the lengthwise direction thereof, as in the foregoing exemplary embodiments, but they may be a plurality of places which are nearer to both the end faces in the lengthwise direction, than the middle part that touches the support face 14a of the first carriage 14 or the front surface 140a of the circuit board 140.

Besides, in the foregoing exemplary embodiments, the second support face 52a of the second protuberance 52 is configured so as to touch the front surface 140a of the circuit board 140 at the position between the two LEDs 141. However, this is not restrictive, but the second support face 52a of the second protuberance 52 may well touch the front surface 140a of the circuit board 140 at, for example, a position which shifts in the widthwise direction of the circuit board 140 relative to the arrayal direction of the LEDs 141.

In the foregoing exemplary embodiments, the heat transmission portion 145a and the heat radiation portion 145b of the heat radiation member 145 have been formed by crooking the plate-like member. However, this is not restrictive, but the heat radiation portion 145b, for example, may well be formed in such a way that a heat radiation fin is mounted on a flat face which is continuous to the heat transmission portion 145a. Besides, the heat radiation portion 145b is not restricted to the one which covers the vertically upper side of the light emission face 141a of the LED 141.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
light emitting elements that emit light for illuminating an original;
a circuit board on which the light emitting elements are installed;
a light guide member into which the light of the light emitting elements enters so as to be guided into a direction of the original;
a support member that supports the circuit board and the light guide member;
a heat radiation member that has
a heat transmission portion to which heat generated in the light emitting elements is transmitted from a surface of the circuit board opposite to a surface thereof where the light emitting elements are installed, and
a heat radiation portion that radiates the heat conducted to the heat transmission portion; and
a reading portion that reads an image of the original with reflection light generated in such a way that the light exiting from the light guide member is reflected from the original.

2. The image reading apparatus according to claim 1,
wherein the heat radiation portion of the heat radiation member is arranged on a vertically upper side relative to the light guide member.

3. The image reading apparatus according to claim 1,
wherein the heat radiation portion of the heat radiation member is formed so as to cover a vertically upper side of a light emission face of the light source.

4. An image forming apparatus comprising:
an image reading apparatus according claim 1; and
an image formation portion that forms an image on a recording material, on the basis of information of the image read by the reading portion of the image reading apparatus.
